(19) United States
(12) Patent Application Publication
(10) Pub. No.: US 2006/0277225 A1
(43) Pub. Date: Dec. 7, 2006

(54) Converting file system metadata structure while the file system remains available

(76) Inventors: Timothy W. Mark, Goffstown, NH (US); David G. Akers, Merrimack, NH (US); Devin P. Borland, Nashua, NH (US); Brian D. Tsao, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/146,862

(22) Filed: Jun. 7, 2005

(51) Int. Cl. G06F 17/30

(52) U.S. Cl. 707/201

(57) ABSTRACT

A system comprises software, a storage subsystem containing user data associated with file system metadata having a first metadata structure, and file system logic to convert the first metadata structure to a second, different metadata structure while the file system remains available such that the software continues to access the file system for accessing the user data.

### BACKGROUND

Data can be stored in various types of storage devices, including magnetic storage devices (such as magnetic disk drives), optical storage devices, integrated circuit storage devices, and so forth. Data stored in storage devices includes user data and metadata. The term “user data” refers to user-created data, program instructions, data associated with applications or other software, and the like. “Metadata” is information that describes the stored user data. Examples of metadata include file names, information relating to ownership and access rights, last modified date, file size, and other information relating to the structure, content, and attributes of files containing user data.

One type of metadata is metadata maintained by a file system. A file system is a mechanism for storing and organizing user data to allow software in a computer to easily find and access the user data (e.g., user data stored in files). File systems are typically associated with operating systems, such as Unix, DOS, Microsoft WINDOWS®, Mac OS, and so forth. A computer can be provided with one file system, or with multiple file systems.

As file system technology advances, new features are often added. To support new features of a file system, the structure or layout of the file system metadata is often changed, such as to add new information fields to the metadata to support the new features.

Also, over time, newly developed software applications may outgrow limits on file sizes imposed by file system metadata. For example, a file system may have been created to accommodate a certain maximum file size. To allow an increase in the maximum file size, the number of bits of information fields relating to file size in the file system metadata may have to be increased, which also changes the metadata structure or layout.

As a new file system metadata layout becomes available, a user may wish to transition to the new layout to use new features or capabilities. Typically, to convert metadata layout, a file system has to be first unmounted (taken offline). A conversion utility is then run against the unmounted file system to change the original file system metadata layout to the new file system metadata layout. Depending on the size of the file system, the time that a file system remains offline during metadata layout conversion can be lengthy. While the file system is offline, software (e.g., application software) is not able to access user data managed by the offline file system. If the offline file system is part of a server computer in a networked environment, for example, then multiple network users would be unable to access data maintained by the offline file system.

Another technique of migrating to a new file system metadata layout is by backing up user data associated with an existing file system, removing the original file system having an original metadata layout, creating a new file system having a new metadata layout, and restoring the user data from the backup. This metadata layout conversion technique also involves substantial downtime for user data associated with the file system since the file system is offline during the user data backup, original file system removal, new file system creation, and user data restoring procedures.

### BRIEF DESCRIPTION OF THE DRAWINGS

FIG. 1A-1C illustrate an exemplary system that includes a metadata layout conversion mechanism according to an embodiment for converting file system metadata layout from a first layout to a second, different layout.

FIG. 2 is a flow diagram of a process of converting the file system metadata layout, according to an embodiment.

### DETAILED DESCRIPTION

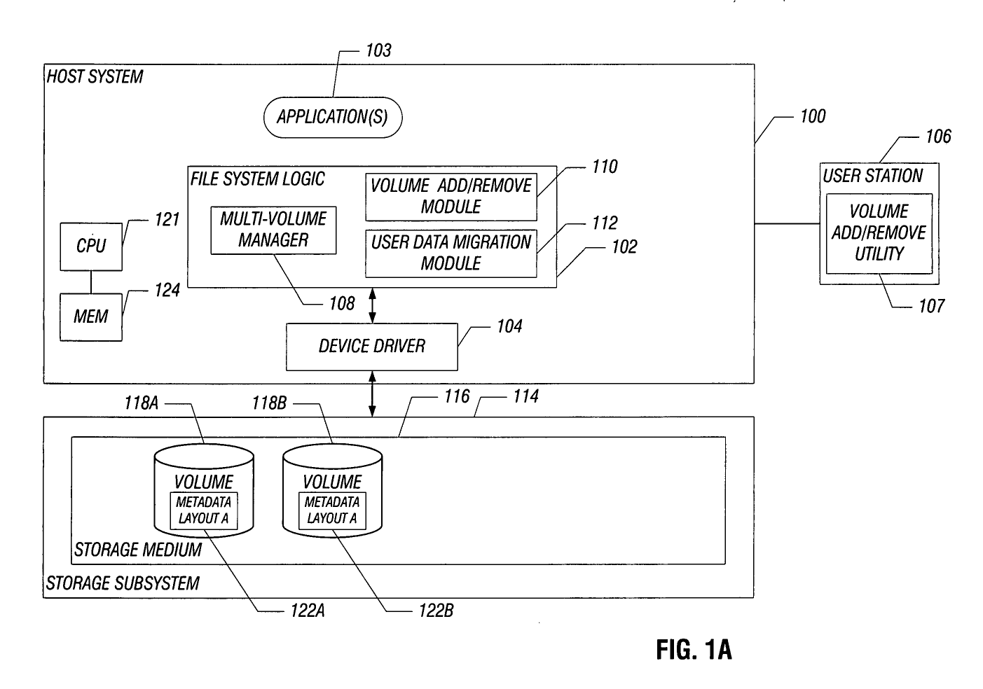

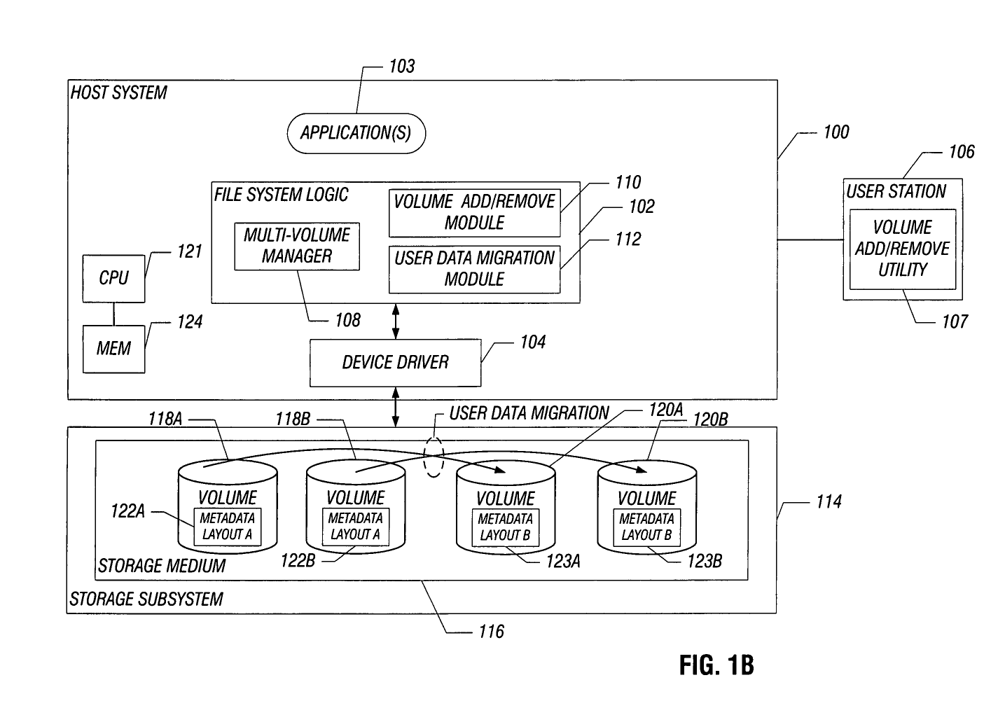

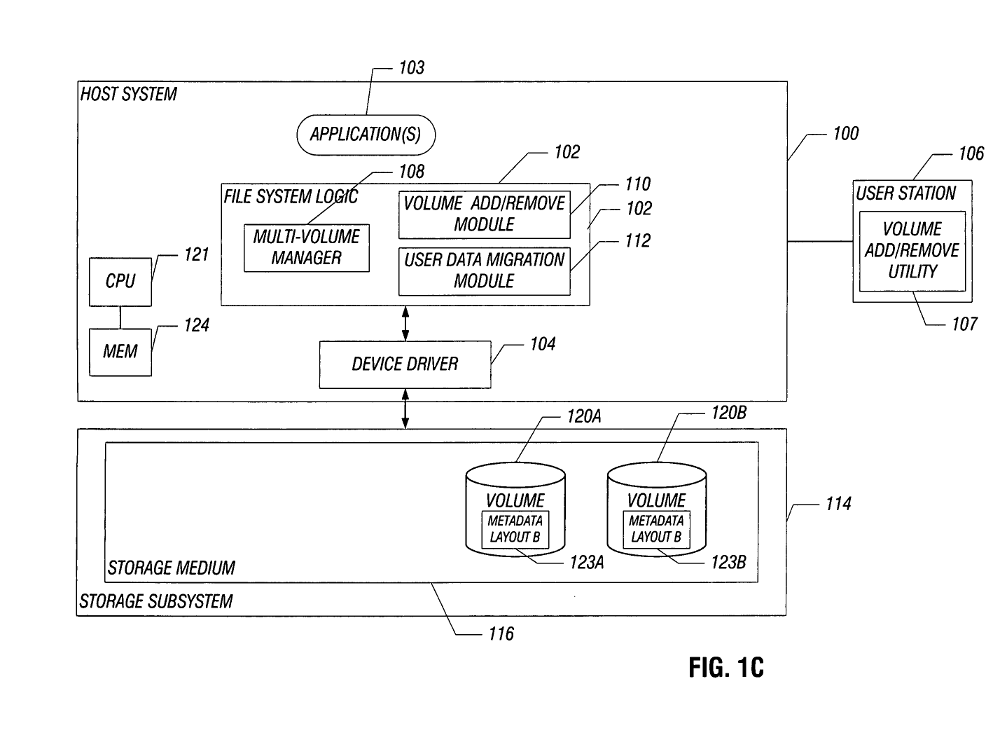

As depicted in FIG. 1A, a host system 100 is coupled to a storage subsystem 114, where the storage subsystem 114 includes a storage medium 116 for storing user data. Note that although the storage subsystem 114 is shown as separate from the host system 100, the storage subsystem 114 can be part of the host system 100. Also, the label “host” is used for exemplary purposes, as mechanisms according to some embodiments can be used in other types of computer systems in other implementations. The storage subsystem 114 can be implemented with various types of storage devices, including disk-based storage devices, integrated circuit storage devices, and other types of storage devices. Examples of the storage medium 116 include disk-based storage medium (e.g., magnetic or optical disk or disks), integrated circuit-based storage medium, nanotechnology or microscopy-based storage medium, or other types of storage media. The term “storage medium” refers to either a single storage medium or multiple storage media (e.g., multiple disks, multiple chips, etc.).

The storage medium 116 is able to store user data in one or plural volumes 118A, 118B. The term “user data” broadly refers to data that is associated with either a user, application, or other software in a computer system. Examples of user data include user files, software code, and data maintained by applications or other software.

Although two volumes 118A, 118B are depicted in FIG. 1A, it is contemplated that one volume or more than two volumes can be used in other implementations. A “volume” refers to either a logical or physical representation of a portion of the storage medium 116. Each of the volumes 118A, 118B is associated with respective file system metadata 122A, 122B. Metadata generally refers to data that describes the user data (e.g., structure, content, and attributes of the user data) stored in each volume 118A, 118B. The file system metadata 122A, 122B has a file system metadata structure, also referred to as a “file system metadata layout.” The file system metadata structure or file system metadata layout refers to the layout or format used by a file system for storing the file system metadata 122A, 122B. In the example of FIG. 1A, the file system metadata 122A, 122B is associated with file system metadata layout A. If the storage medium 116 is implemented with one or plural disks, the file system metadata layout is referred to as a file system disk layout.

The file system metadata layout can change to support new features added to the file system, or to support larger file sizes, as examples. The file system metadata includes information fields that describe various characteristics of user data. The information fields in file system metadata having a first file system metadata layout are different from information fields in file system metadata having a second file system metadata layout. In accordance with some embodiments, the file system metadata layout (labeled “layout A” in FIG. 1A) of the file system metadata 122A, 122B can be efficiently converted by a conversion mechanism to a different file system metadata layout (labeled “layout B” in FIGS. 1B-1C). The conversion mechanism is able to convert the file system metadata layout from one version to another without taking the file system offline, such as by unmounting the file system or otherwise making the file system unavailable for use by software (e.g., software application(s) 103) in the host system 100. By keeping the file system online in the host system 100 while the metadata layout conversion is proceeding, user data managed by the file system remains available to software. A file system is said to be online or available if software is able to access the file system for the purpose of accessing user data.

A “file system” refers to the mechanism used for storing and organizing user data on the storage medium 116. The file system implemented in the host system 100 of FIG. 1A includes file system logic 102 and file system metadata (e.g., 122A, 122B). The file system logic 102 performs access control and other management and storage tasks (e.g., create, move, and delete files; modify files; deny or allow access to files) with respect to the metadata 122A, 122B and user data. The file system logic 102 communicates with the storage subsystem 114 through a device driver 104.

The file system can be part of an operating system (not shown), such as a Unix operating system, WINDOWS® operating system, DOS, Mac OS, or other operating system. In other implementations, the file system can be separate from an operating system. Although only one file system is depicted in FIG. 1A, other implementations include multiple file systems mounted in the host system 100 and storage subsystem 114. In some implementations, a file system can be a removable file system. A removable file system can be mounted in the system to make the file system available for access by software. A removable file system can also be unmounted, which makes the file system unavailable for access by software.

To read or write user data stored in the storage subsystem 114, one or more software applications 103 issue read and write requests through the file system logic 102. The application(s) 103, file system logic 102, device driver 104, and other software in the host system 100 are executable on a central processing unit (CPU) 121, which is connected to memory 124.

The file system logic 102 has multi-volume capability, which allows the file system logic 102 to create multiple volumes 118A, 118B for storing user data. The multiple volumes are managed by a multi-volume manager 108 in the file system logic 102. The file system logic 102 also includes a volume add/remove module 110 for adding or removing volumes from the storage subsystem 114. Also, the file system logic 102 includes a user data migration module 112 to migrate user data from one volume to another volume for the purpose of changing file system metadata layout, as described in greater detail below. Note that the user data migration module 112 can perform user data migration for other purposes as well, such as file system defragmentation, load balancing, and so forth.

In one embodiment, the conversion mechanism to enable the efficient conversion of the file system metadata layout includes the volume add/remove module 110 and user data migration module 112 that are part of the file system logic 102. In other embodiments, the conversion mechanism can be implemented with modules outside the file system logic 102.

A user can access the host system 100 through a user station 106. Alternatively, the host system 100 itself can provide a user interface to allow access by a user. The user station 106 includes a volume add/remove utility 107 that enables a user at the user station 106 to send requests to the file system logic 102 for adding or removing volumes, such as for the purpose of converting file system metadata layout.

In accordance with some embodiments, changing file system metadata layout is accomplished by adding new volumes to the storage subsystem 114, and migrating user data from the original volumes to the new volumes. “Migrating” user data from a first volume to a second volume refers to copying or moving the user data from the first volume to the second volume. The new volumes are set up such that the file system metadata associated with the new volumes have a second file system metadata layout (layout B in FIG. 1B) that is different from the original file system metadata layout (layout A).

The creation of new volumes is illustrated in FIG. 1B, where new volumes 120A, 120B have been added, each associated with metadata 123A, 123B having file system metadata layout B. The addition of volumes 120A, 120B is controlled by the volume add/remove module 110 in the file system logic 102. The volume add/remove module 110 adds the volumes 120A, 120B in response to commands issued by the user station 106 (or from some other source).

In some implementations, migration of user data from volumes 118A, 118B to respective volumes 120A, 120B is initiated in response to a command from the user station 106 (or from another source) to delete the original volumes 118A, 118B. In response to a command to delete the original volumes 118A, 118B, the volume add/remove module 110 interacts with the user data migration module 112 to cause the migration of user data from the original volumes 118A, 118B to the new volumes 120A, 120B. The migration of user data is illustrated by arrows depicted in FIG. 1B. Note that although user data is migrated from the original volumes 118A, 118B to new volumes 120A, 120B, the file system metadata is not migrated (since the new volumes 120A, 120B are associated with a different metadata layout). In other embodiments, other techniques for migrating user data between volumes can be employed.

FIG. 1C shows the state of the storage subsystem 114 after user data has been migrated from the original volumes 118A, 118B to the new volumes 120A, 120B, and after removal of the original volumes 118A, 118B. In FIG. 1C, the user data in existence prior to the user data migration, but which was associated with metadata 122A, 122B having file system metadata layout A, is now stored on the storage medium 116 in accordance with metadata 123A, 123B having the new file system metadata layout B.

Effectively, according to some embodiments of the invention, to convert file system metadata layout, user data is migrated from a first set of volume(s) to a second set of volume(s), where the first set of volume(s) is (are) associated with file system metadata having a first file system metadata layout, and the second set of volume(s) is (are) associated with file system metadata having a second file system metadata layout. In this manner, conversion of the file system metadata layout is accomplished while the file system remains available (online) for access by software in the host system 100 (e.g., the application(s) 103) or by external devices. In other words, during the conversion of the file system metadata layout, the file system (including file system logic 102 and file system metadata) does not have to be first unmounted (or otherwise taken offline) to perform the file system metadata layout conversion. This enables access of user data in the storage subsystem that is managed by the file system while the file system metadata layout conversion is proceeding. As noted above, in some implementations, the host system 100 and storage subsystem 114 can have multiple mounted file systems. Metadata layout conversion according to techniques described above can also be performed for each of the other file systems.

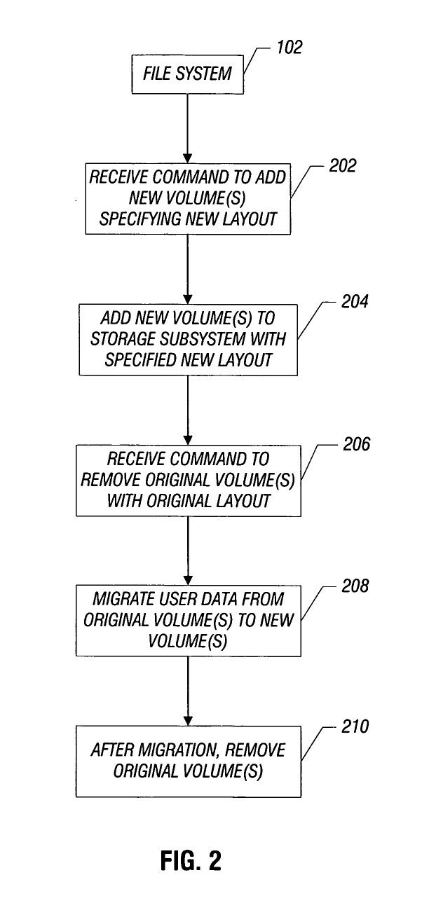

FIG. 2 illustrates a process according to some embodiments to perform conversion from a first file system metadata layout to a second, different file system metadata layout, in accordance with some embodiments of the invention. The file system logic 102 receives (at 202) a command (or multiple commands) to add new volume(s), where the one or more commands specify the new file system metadata layout that is desired. The volume add/remove module 110 in the file system logic 102 adds (at 204) the new volume(s) to the storage subsystem 114 with the specified new file system metadata layout. The new file system metadata layout specifies the new structure for metadata associated with the user data stored in the newly added volume(s).

Next, the file system logic 102 receives (at 206) a command (or multiple commands) to remove the original volume(s) associated with the original file system metadata layout. In response to the command(s) to remove the original volume(s), the user data migration module 112 in the file system logic 102 migrates (at 208) user data from the original volume(s) to the new volume(s). After migration of the user data, the volume add/remove module 110 removes (at 210) the original volume(s), leaving the new volume(s) associated with the new file system metadata layout. During the time that the new volume(s) is (are) being added and the user data migration is occurring, the user data remains available to host system software (or external devices).

The flow diagram of FIG. 2 is exemplary, where the acts/blocks of the figure can be added, removed, altered, and so forth, and still be covered by embodiments of the invention.

Instructions of software routines (including the modules 102, 103, 108, 110, 112 in FIGS. 1A-1C) are loaded for execution on a processor (e.g., CPU 121). The processor includes microprocessors, microcontrollers, processor modules or subsystems (including one or more microprocessors or microcontrollers), or other control or computing devices.

Data and instructions (of the software) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A system comprising:
software;
a storage subsystem containing user data associated with file system metadata having a first metadata structure, the file system metadata associated with a file system; and
file system logic to convert the first metadata structure to a second, different metadata structure while the file system remains available such that the software continues to access the file system for accessing the user data.

2. The system of claim 1, wherein the file system logic converts the first metadata structure to the second metadata structure by migrating the user data from a first volume to a second volume, wherein the first volume is associated with file system metadata having the first metadata structure and the second volume is associated with file system metadata having the second metadata structure.

3. The system of claim 2, wherein the file system logic comprises a volume add/remove module to add the second volume.

4. The system of claim 3, wherein the volume add/remove module removes the first volume after user data has been migrated from the first volume to the second volume.

5. The system of claim 4, wherein the volume add/remove module adds the second volume and removes the first volume in response to one or more commands.

6. The system of claim 2, wherein the file system logic comprises a user data migration module to migrate the user data from the first volume to the second volume.

7. The system of claim 1, wherein the file system metadata contains information fields describing the user data, the information fields according to the first metadata structure being different from information fields according to the second metadata structure.

8. The system of claim 1, wherein the file system logic converts the first metadata structure to the second metadata structure in response to one or more commands, the one or more commands specifying the second metadata structure.

9. A computer-executed method comprising:
storing file system metadata having a first layout, the file system metadata having the first layout associated with a first volume in a storage system; and
converting a layout of the file system metadata from the first layout to a second, different layout by migrating user data from the first volume to a second volume in the storage system, wherein the second volume is associated with file system metadata having the second layout,
wherein converting the layout of the file system metadata occurs while the file system remains online.

10. The method of claim 9, further comprising receiving at least one command to add the second volume, where the at least one command specifies the second layout.

11. The method of claim 10, further comprising receiving at least one command to remove the first volume, wherein migrating user data from the first volume to the second volume is performed in response to the at least one command to remove the first volume.

12. The method of claim 9, wherein migrating the user data from the first volume to the second volume is performed under control of file system logic in the file system.

13. The method of claim 12, wherein migrating the user data from the first volume to the second volume is performed without migrating file system metadata from the first volume to the second volume.

14. The method of claim 9, wherein converting from the first layout to the second layout comprises converting from a first file system metadata structure to a second, different file system metadata structure.

15. The method of claim 9, wherein the storage system has plural first volumes associated with the file system metadata having the first layout, and
wherein migrating the user data comprises migrating the user data from the plural first volumes to plural second volumes, the plural second volumes associated with the file system metadata having the second layout.

16. The method of claim 9, further comprising removing the first volume after migrating user data from the first volume to the second volume.

17. An article comprising at least one storage medium containing instructions that when executed cause a computer to:
store user data associated with metadata having a first structure, the metadata associated with a file system;
convert the first structure of the metadata to a second, different structure to change a characteristic of the file system while the file system remains available to software in the computer; and
enable the software in the computer to access the user data while conversion from the first structure to the second structure is occurring.

18. The article of claim 17, wherein converting the first structure of the metadata to the second structure comprises migrating the user data from a first volume to a second volume, wherein the first volume is associated with metadata having the first structure, and the second volume is associated with metadata having the second structure.

19. The article of claim 18, wherein migrating the user data from the first volume to the second volume is performed by file system logic.

20. The article of claim 18, wherein migrating the user data from the first volume to the second volume is in response to a command to delete the first volume.

21. A system comprising:
software;
a file system having a volume add/remove module and a user data migration module;
a storage subsystem to store a first volume containing user data associated with file system metadata having a first file system metadata structure,
in response to one or more first commands, the volume add/remove module to add a second volume that is associated with file system metadata having a second, different file system metadata structure, the one or more first commands specifying the second file system metadata structure, and
in response to one or more second commands to remove the first volume, the user data migration module to migrate the user data from the first volume to the second volume, migration of the user data from the first volume to the second volume effecting file system metadata conversion from the first file system metadata structure to the second file system metadata structure,
wherein the file system remains online and available for access by the software while file system metadata structure conversion is occurring.
